(19) United States
(12) Patent Application Publication
(10) Pub. No.: US 2015/0363706 A1
(43) Pub. Date: Dec. 17, 2015

(54) FUSION OF DATA FROM HETEROGENEOUS SOURCES

(71) Applicant: AGT International GmbH, Zurich (CH)

(72) Inventors: Marco HUBER, Weinheim (DE); Christian Debes, Darmstadt (DE); Roel Heremans, Darmstadt (DE); Tim Van Kasteren, Barcelona (ES)

(21) Appl. No.: 14/740,298

(22) Filed: Jun. 16, 2015

(30) Foreign Application Priority Data
Jun. 16, 2014 (SG) 10201403292W

(51) Int. Cl. G06N 7/00; G06F 17/30; G06N 5/02; H04L 29/08

(52) U.S. Cl. CPC G06N 7/005; H04L 67/12; G06F 17/30876; G06N 5/02

(57) ABSTRACT

A system and method to perform multisensory data fusion in a distributed sensor environment for object identification classification. Embodiments of the invention are sensor-agnostic and capable handling a large number of sensors of different types via a gateway which transmits sensor measurements to a fusion engine according to predefined rules. A relation exploiter allows combining sensor measurements with information on object relationships from a knowledge base. Also included in the knowledge base is a travel model for objects, along with a graph generator to enable forecasting of object locations for further correlation of sensor data in object identification. Multiple task managers allow multiple fusion tasks to be performed in parallel for flexibility and scalability of the system.

### CROSS REFERENCE TO RELATED APPLICATIONS

This application claims the benefit of Singapore (SG) Application Number 10201403292W filed on Jun. 16, 2014 which is hereby incorporated by reference in their entirety.

### BACKGROUND

Complex data collected by sensors, such as images captured by cameras, is often difficult to interpret, on account of noise and other uncertainties. A non-limiting example of complex data interpretation is identifying a person in a public space by means of cameras or biometric sensors. Other types of sensing used in such a capacity include face recognition, microphones, and license plate readers (LPR).

Existing approaches for identification systems typically perform identification based solely on a single sensor or on a set of sensors deployed at the same location. In various practical situations, this results in a loss of identification accuracy,

Techniques for data fusion are well-known, in particular utilizing Bayesian methodologies, but these are typically tailored for specific sensor types or data fusion applications, often focusing on approximation methods for evaluating the Bayesian fusion formulas. When a large number of sensors is used, scalability is an important requirement from a practical perspective. In addition, when different types of sensors are used, the system should not be limited to a particular sensor type.

It would be desirable to have a reliable means of reducing the uncertainties and improving the accuracy of interpreting sensor data, particularly for large numbers of sensors of mixed types. This goal is met by embodiments of the present invention.

### SUMMARY

Embodiments of the present invention provide a system to perform multisensory data fusion for identifying an object of interest in a distributed sensor environment and for classifying the object of interest. By accumulating the identification results from individual sensors an increase in identification accuracy is obtained.

Embodiments of the present invention are sensor-agnostic and are capable handling a large number of sensors of different types.

Exploiting additional information besides sensor measurements is uncommon. While the usage of road networks and motion models exists (see e.g. [2]), additionally exploiting relations between different object is not part of state-of-the-art.

According to various embodiments of the present invention, instead of interpreting data obtained from similar sensors individually or separately, data from multiple sensors is fused together. This involves fusing data from multiple sensors of the same type (e.g., fusing only LPR data), but also fusing data from multiple sensors of different types (e.g., fusing LPR data with face recognition data). Embodiments of the invention provide for scaling systems across different magnitudes of sensor numbers.

Embodiments of the present invention can be used in a wide spectrum of object identification systems, including, but not limited to: identification of cars in a city via license plate readers; and personal identification via biometric sensors and cameras. Embodiments of the invention are especially well-suited in situations where identification accuracy of surveillance systems is relatively low, such as with personal identification via face recognition in public areas.

An embodiment of the invention can be employed in conjunction with an impact/threat assessment engine, to forecast a potential threat level of an object, potential next routes of the object, etc., based on the identification of the object as determined by the embodiment of the invention. In a related embodiment, early alerts, and warnings are raised when the potential threat level exceeds a predetermined threshold, allowing appropriate counter measures to be prepared.

General areas of application for embodiments of the invention include, but are not limited to fields such as water management and urban security.

Therefore, according to an embodiment of the present invention there is provided a data fusion system for identifying an object of interest, the data from multiple data sources, the system including: (a) a gateway, for receiving one or more sensor measurements from a sensor set; (b) a knowledge base stored in a non-transitory data storage, the knowledge base for storing information about objects of interest; (c) a relation exploiter, for extracting one or more objects from the knowledge base related to the object of interest; (d) a fusion engine, for receiving the one or more sensor measurements from the gateway, the fusion engine comprising: (e) an orchestrator module, for receiving the one or more objects from the relation exploiter related to the object of interest and for combining the one or more sensor measurements therewith; (f) at least one task manager, for receiving a fusion task from the orchestrator module, for creating a fusion task data structure therefrom, and for managing the fusion task data structure to identify the object of interest; and (g) a Bayesian fusion unit for performing the fusion task for the at least one task manager.

According to another embodiment of the present invention there is provided a data fusion system for identifying an object of interest, the data from multiple data sources, the system comprising:
a gateway, for receiving sensor measurements from a sensors set;
a knowledge base stored in a non-transitory data storage, the knowledge base for storing information about plurality of objects and relationships there-between;
a relation exploiter, for extracting one or more of the objects from the knowledge base, responsive to their relationship to the object of interest;
a fusion engine, for receiving the sensor measurements from the gateway, the fusion engine comprising:
   an orchestrator module, for combining at least two of the sensor measurements, responsive to the relationships of the one or more objects to the object of interest and;
   at least one task manager, for receiving a fusion task from the orchestrator module, for creating a fusion task data structure from the at least two combined sensor measurements, and for managing the fusion task data structure to identify the object of interest; and
   a Bayesian fusion unit for performing the fusion task for the at least one task manager.

It is another object of the present invention to provide the data fusion system as mentioned above, wherein the at least one task manager is a plurality of task managers.

It is another object of the present invention to provide the data fusion system as mentioned above, wherein the knowledge base further contains a travel model of at least one of the plurality of objects.

It is another object of the present invention to provide the data fusion system as mentioned above, further comprising a graph generator, for generating a graphical representation of the potential locations of the at least one object according to the travel model.

It is another object of the present invention to provide the data fusion system as mentioned above, wherein the relation exploiter extracts one or more identifiers for the one or more objects from the knowledge base related to the object of interest.

According to another embodiment of the present invention there is provided a computer implemented data fusion method for identifying an object of interest, the data from multiple data sources, the method comprising:
receiving sensor measurements from a sensors set;
extracting one or more objects related to the object of interest from a knowledge base, the knowledge base comprising information about plurality of objects and relationships there-between;
managing at least one fusion task, responsive to the relationships of the one or more objects to the object of interest, the fusion task comprising fusing at least two of the sensor measurements into a data structure therefrom; and
using the data structure to identify the object of interest;
   wherein at least one of fusion tasks comprising Bayesian fusion.

According to another embodiment of the present invention there is provided a non-transitory computer readable medium (CRM) that, when loaded into a memory of a computing device and executed by at least one processor of the computing device, configured to execute the steps of a computer implemented data fusion method for identifying an object of interest, the data from multiple data sources, the method comprising:
receiving sensor measurements from a sensors set;
extracting one or more objects related to the object of interest from a knowledge base, the knowledge base comprising information about plurality of objects and relationships there-between;
managing at least one fusion task, responsive to the relationships of the one or more objects to the object of interest, the fusion task comprising fusing at least two of the sensor measurements into a data structure therefrom; and
using the data structure to identify the object of interest;
   wherein at least one of fusion tasks comprising Bayesian fusion.

It is another object of the present invention to provide the data fusion method as mentioned above, wherein the knowledge base further contains a travel model of at least one of the plurality of objects.

It is another object of the present invention to provide the data fusion method as mentioned above, further comprising generating a graphical representation of the potential locations of the at least one object according to the travel model.

It is another object of the present invention to provide the data fusion method as mentioned above, further comprising extracting one or more identifiers for the one or more objects from the knowledge base related to the object of interest.

### BRIEF DESCRIPTION OF THE DRAWINGS

The subject matter disclosed may best be understood by reference to the following detailed description when read with the accompanying drawings in which:

FIG. 1 is a conceptual block diagram of a system according to an embodiment of the present invention.

For simplicity and clarity of illustration, elements shown in the FIGURE are not necessarily drawn to scale, and the dimensions of some elements may be exaggerated relative to other elements. In addition, reference numerals may be repeated among the FIGURE to indicate corresponding or analogous elements.

### DETAILED DESCRIPTION

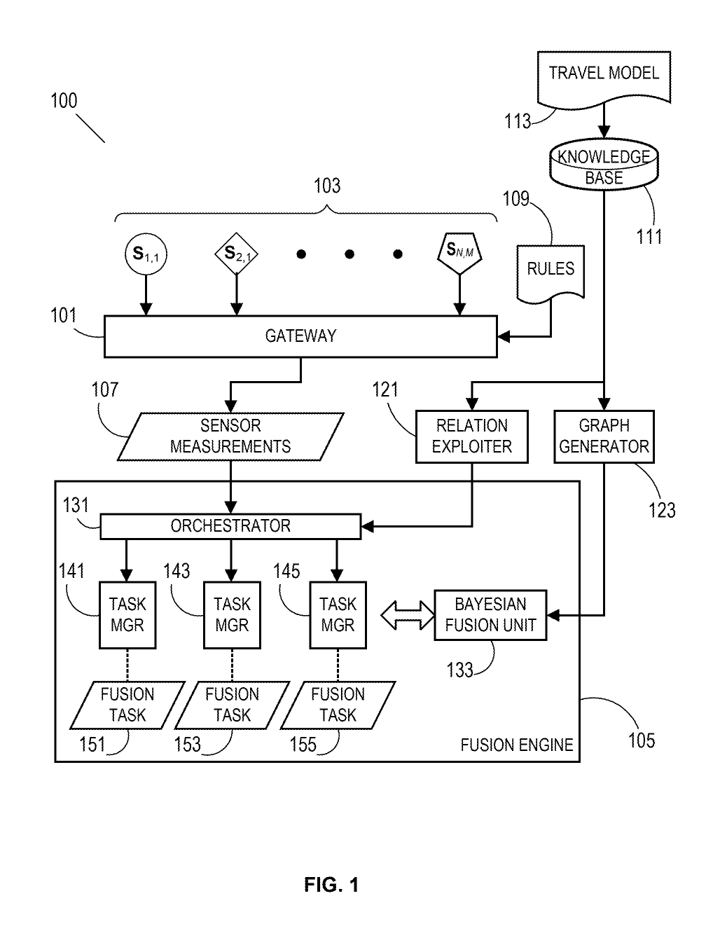

FIG. 1 is a conceptual block diagram of a system 100 according to an embodiment of the present invention. A gateway 101 is an interface between a sensor set 103 and a fusion engine 105. Sensors in sensor set 103 are labeled according to a scheme by which S_{t,i} represents a sensor of type t, where t=1, 2, . . . , N, for a total of N different sensor types; and i=1, 2, . . . , M, where M is the total number of sensors of type t.

Gateway 101 is indifferent to sensor data and merely transmits sensor measurements 107 to fusion engine 105, if a set of predefined rules 109 (such as conditions) is satisfied. Non-limiting examples of rule include: only observations in a predefined proximity to a certain object are transmitted to fusion engine 105; and only measurements with a confidence value above a predetermined threshold are transmitted to fusion engine 105. In a related embodiment of the invention, this implements a push communication strategy and thereby, reduces internal communication overhead.

Fusion engine 105 performs the actual fusion of sensor measurements 107, and manages the creation and execution of fusion tasks.

A knowledge base 111 contained in a non-transitory data storage containing information about objects of interest. Knowledge base 111 stores a travel model 113 of an object of interest, along with parameters of travel model 113. Knowledge base 111 also contains map information and information about relationships between objects.

A relation exploiter 121 extracts objects related to an object of interest from knowledge base 111. In a related embodiment relation exploiter 121 extracts an identifier (non-limiting examples of which include a link or an ID) of objects related to the object of interest.

A graph generator 123 provides a graphical representation of arbitrary map information, such as of potential locations of an object of interest according to travel model 113. In a related embodiment, graph generator 123 pre-computes the graphical representation to reduce run-time computational load; in another related embodiment, graph generator 123 computes the graphical representation at run time, such as when it becomes necessary to update a map in real time.

Gateway 101 transmits sensor measurements 107 to fusion engine 105. Within fusion engine 105, an orchestrator module 131 decides if a particular sensor measurement belongs to an already existing fusion task (such as a fusion task 151, a fusion task 153, or a fusion task 155) or if a new fusion task has to be generated. To assign a measurement to an active fusion task, an orchestrator module 131 compares and correlated the measurement with every active fusion task. Orchestrator module 131 can further merge fusion tasks, if it turns out that two or more fusion tasks are trying to identify the same object. Fusion tasks 151, 153. and 155 are data structures, each of which store a class-conditional probability P(Tᵢ), the probability that an object belongs to object class Tᵢ, with i=1, 2, . . . L, where L is the number of object classes.

Fusion tasks 151, 153, and 155 are managed by task managers 141, 143, and 145 respectively, which maintain fusion task data, communicate with a Bayesian fusion unit 133, and close their respective assigned fusion task at completion of identifying and/or classifying the object of interest. Bayesian fusion unit 133 performs the actual fusion calculations and hands back the results to the relevant task manager, for storage of the result in the appropriate fusion task. For compactness and clarity, FIG. 1 illustrates three task managers 141, 143, and 145 in a non-limiting example. It is understood that the number of task managers in an embodiment of the invention is not limited to any particular number, and that FIG. 1 and the associated descriptions show three task managers 141, 143, and 145 for purposes of illustration and explanation only and are non-limiting—a different number of task managers may be used as appropriate.

For Bayesian fusion unit 133, it is assumed that:
the sensor measurements are conditionally independent; and
a miss-detection probability c_{f} is known.

The first assumption is common in data fusion based on Bayesian inference. It allows recursive processing and thus reduces computational complexity and memory requirements. Knowing the miss-detection probability c_{f} is necessary; otherwise, it is not possible to improve the confidence value/class-conditional probabilities.

Given class-conditional probabilities Tᵢ, i=1, 2, . . . L, stored in the selected fusion task, these probability values can be updated given the new sensor measurement of sensor Sⱼ by means of Bayes' theorem according to:

P(Tᵢ|Sⱼ=Tₖ)=cₙ·P(Sⱼ=Tₖ|Tᵢ)·P(Tᵢ) (1)

with

P(Sᵢ=Tₖ|Tᵢ)=vⱼ·δₖᵢ+c_{f}·(1−δₖᵢ) (2)

where
vⱼ is the confidence value of the measurement of sensor Sⱼ;
δₖᵢ is Kronecker's delta (=1 when k=i, and =0 otherwise);
c_{f} is the miss-detection probability; and

$${c}_{n} = \frac{1}{{\sum }_{i = 1}^{L} P ( {S}_{j} = {T}_{k} \vert {T}_{i} ) \cdot P ( {T}_{i} )}$$

is a normalization constant which ensures that all updated class-conditional probabilities P(Tᵢ|Sⱼ), i=1, 2, . . . L sum to 1.

The probability P(Sⱼ=Tₖ|Tᵢ) is the likelihood that sensor Sⱼ observed object Tₖ given that the actual object is Tᵢ. If Tₖ=Tᵢ (that is, Sⱼ has detected object Tᵢ, and therefore k=i), then Equation (2) evaluates to vⱼ. On the other hand, if Tₖ≠Tᵢ (that is, Sⱼ has detected any other object than Tᵢ, and therefore k≠i), then Equation (2) evaluates to c_{f}, indicating a miss-detection. The updated probability values are stored again in the appropriate fusion task.

If a new fusion task needs to be instanciated for a given object, a task manager (such as task manager 141, 143, or 145) retrieves the object's travel model 113 (e.g., kinematics such as velocity, steering angle, or acceleration of a car) and its parameters (e.g., maximum velocity and acceleration of a car) from knowledge base 111. Thus, travel model 113 considers dynamic properties of the object and allows calculating, for instance, the maximum traveled distance within a given time interval. Travel model 113, together with a graph, obtained from knowledge base 111 via a graph generator 123, thereby represents the potential travel routes of the object, and allows Bayesian fusion unit 133 to estimate the most likely location of the object together with its class probability. If a sensor measurement does not directly correspond to the object, but is related to the object, orchestrator module 131 can exploit this relationship by means of relation exploiter 121 in order to assign the sensor measurement to the appropriate fusion task. In a non-limiting example, if the focus is on identifying a person in a shopping mall, even observations from a LPR can be of help, because knowledge base 111 can include a relationship between a car and the person who owns the car. Thus, having observed the car by means of a LPR system near the shopping mall can increase the evidence that the person in question is actually in the shopping mall.

Benefits afforded by embodiments of the present invention include:

Gateway 101 accepts data input from different sensor types without regard to their data 10 format, and provides flexibility and scalability in the number of sensors.

Gateway 101 integrates rules 109 to moderate data transmission to fusion engine 105, to ensure that sensor measurements 107 are sent to fusion engine 105 only when certain predetermined conditions are met.

Embodiments of the invention exploit relationships between different objects and object types, corresponding to the integration of JDL level 2 data fusion, which is rarely currently realized.

Embodiments of the invention orchestrate fusion tasks based not only on sensor measurements, but also on relationships between objects.

Embodiments of the invention improve object identification by combining object relationships, object travel model 113, graph generation for representing the environment, and Bayesian fusion.

Multiple task managers 141, 143, and 145 handle processing of fusion tasks in parallel, allowing flexibility and scalability in the number of fusion tasks that can be handled simultaneously in real time.

What is claimed is:

1. A data fusion system for identifying, an object of interest, the data from multiple data sources, the system comprising:
a gateway, for receiving sensor measurements from a sensors set;
a knowledge base stored in a non-transitory data storage, the knowledge base for storing information about plurality of objects and relationships there-between;
a relation exploiter, for extracting one or more of the objects from the knowledge base, responsive to their relationship to the object of interest;
a fusion engine, for receiving the sensor measurements from the gateway, the fusion engine comprising:
an orchestrator module, for combining at least two of the sensor measurements, responsive to the relationships of the one or more objects to the object of interest and;
at least one task manager, for receiving a fusion task from the orchestrator module, for creating a fusion task data structure from the at least two combined sensor measurements, and for managing the fusion task data structure to identify the object of interest; and
a Bayesian fusion unit for performing the fusion task for the at least one task manager.

2. The data fusion system of claim 1, wherein the at least one task manager is a plurality of task managers.

3. The data fusion system of claim 1, wherein the knowledge base further contains a travel model of at least one of the plurality of objects.

4. The data fusion system of claim 3, further comprising a graph generator, for generating a graphical representation of the potential locations of the at least one object according to the travel model.

5. The data fusion system of claim 1, wherein the relation exploiter extracts one or more identifiers for the one or more objects from the knowledge base related to the object of interest.

6. A computer implemented data fusion method for identifying an object of interest, the data from multiple data sources, the method comprising:
receiving sensor measurements from a sensors set;
extracting one or more objects related to the object of interest from a knowledge base, the knowledge base comprising information about plurality of objects and relationships there-between;
managing at least one fusion task, responsive to the relationships of the one or more objects to the object of interest, the fusion task comprising fusing at least two of the sensor measurements into a data structure therefrom; and
using the data structure to identify the object of interest;
wherein at least one of fusion tasks comprising Bayesian fusion.

7. The method of claim 6, wherein the knowledge base further contains a travel model of at least one of the plurality of objects.

8. The method of claim 7, further comprising generating a graphical representation of the potential locations of the at least one object according to the travel model.

9. The method of claim 6, further comprising extracting one or more identifiers for the one or more objects from the knowledge base related to the object of interest.

10. A non-transitory computer readable medium (CRM) that, when loaded into a memory of a computing device and executed by at least one processor of the computing device, configured to execute the steps of a computer implemented data fusion method for identifying an object of interest, the data from multiple data sources, the method comprising:
receiving sensor measurements from a sensors set;
extracting one or more objects related to the object of interest from a knowledge base, the knowledge base comprising information about plurality of objects and relationships there-between;
managing at least one fusion task, responsive to the relationships of the one or more objects to the object of interest, the fusion task comprising fusing at least two of the sensor measurements into a data structure therefrom; and
using the data structure to identify the object of interest;
wherein at least one of fusion tasks comprising Bayesian fusion.
